(19) United States
(12) Patent Application Publication
(10) Pub. No.: US 2025/0251693 A1
(43) Pub. Date: Aug. 7, 2025

(54) DEVELOPING DEVICE AND IMAGE FORMING APPARATUS

(71) Applicants: Taira Otsuka, KANAGAWA (JP); Shuichi Nakagawa, KANAGAWA (JP); Akihiro Kawasaki, KANAGAWA (JP); Yutaro Kaku, KANAGAWA (JP); Yasuhide Matsuno, KANAGAWA (JP); Shintaro Yamada, OSAKA (JP); Hiroaki Kato, KANAGAWA (JP)

(72) Inventors: Taira Otsuka, KANAGAWA (JP); Shuichi Nakagawa, KANAGAWA (JP); Akihiro Kawasaki, KANAGAWA (JP); Yutaro Kaku, KANAGAWA (JP); Yasuhide Matsuno, KANAGAWA (JP); Shintaro Yamada, OSAKA (JP); Hiroaki Kato, KANAGAWA (JP)

(73) Assignee: Ricoh Company, Ltd., Tokyo (JP)

(21) Appl. No.: 19/012,085

(22) Filed: Jan. 7, 2025

(30) Foreign Application Priority Data
Feb. 7, 2024 (JP) 2024-016798

(51) Int. Cl. G03G 21/10; G03G 21/16

(52) U.S. Cl. CPC G03G 21/10; G03G 21/1676

(57) ABSTRACT

A developing device includes a developer bearer, a developer container, a supply rotator, and a layer thickness regulator. The developer bearer is rotatable in a first direction to supply developer to a latent image bearer. The developer container contains the developer to be supplied to the developer bearer. The supply rotator supplies the developer in the developer container to the developer bearer at a contact position at which the supply rotator contacts the developer bearer. The layer thickness regulator forms a layer of the developer having a regulated thickness on the developer bearer. The developer bearer collects residual toner from the latent image bearer. The supply rotator rotates in a second direction opposite the first direction of the developer bearer at the contact position. The supply rotator has a surface of a foam layer including a single foam cell having a diameter smaller than 300 μm.

### CROSS-REFERENCE TO RELATED APPLICATIONS

This patent application is based on and claims priority pursuant to 35 U.S.C. § 119(a) to Japanese Patent Application No. 2024-016798, filed on Feb. 7, 2024, in the Japan Patent Office, the entire disclosure of which is hereby incorporated by reference herein.

### BACKGROUND

### Technical Field

Embodiments of the present disclosure relate to a developing device and an image forming apparatus.

### Related Art

A developing device is known that includes a developer bearer, a developer container, a supply rotator, a layer thickness regulator, and a latent image bearer. Such a developing device supplies developer in the developer container onto a latent image bearer which is rotationally driven. The developing device develops a latent image on the latent image bearer, and at the same time, collects transfer residual toner on the latent image bearer after the layer thickness regulator forms a thin layer of the developer.

For example, a developing device is known that includes a supply roller, i.e., a supply rotator, to collect transfer residual toner in the developing device in a cleanerless image forming apparatus. The supply roller has a surface layer including a urethane foam layer formed of a continuous foam in which cells are connected to each other. In the developing device, the supply roller is rotationally driven to move in a same direction as a surface movement direction of a developing roller, i.e., a developer bearer, at a contact position at which the supply roller contacts the developing roller.

### SUMMARY

In an embodiment of the present disclosure, a developing device includes a developer bearer, a developer container, a supply rotator, and a layer thickness regulator. The developer bearer is rotatable in a first direction to supply developer to a latent image bearer. The developer container contains the developer to be supplied to the developer bearer. The supply rotator supplies the developer in the developer container to the developer bearer at a contact position at which the supply rotator contacts the developer bearer. The layer thickness regulator forms a layer of the developer having a regulated thickness on the developer bearer. The developer bearer collects residual toner from the latent image bearer. The supply rotator rotates in a second direction opposite the first direction of the developer bearer at the contact position. The supply rotator has a surface of a foam layer including a single foam cell having a diameter smaller than 300 μm.

In another embodiment of the present disclosure, an image forming apparatus includes a latent image bearer and the developing device including the developer bearer to collect the residual toner from the latent image bearer.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration of an image forming apparatus, according to an embodiment of the present disclosure;

FIG. 2 is a diagram illustrating an image forming device of the image forming apparatus of FIG. 1, according to an embodiment of the present disclosure; and

FIG. 3 is a diagram illustrating a configuration of a developing device of the image forming apparatus of FIG. 1, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings.

An image forming apparatus according to embodiments of the present disclosure is an electrophotographic image forming apparatus, and is a so-called single-drum type direct transfer monochrome apparatus. However, embodiments of the present disclosure are also applicable to other image forming apparatuses such as a one drum type intermediate transfer type full-color apparatus, a four tandem type direct transfer type or intermediate transfer type full-color apparatus.

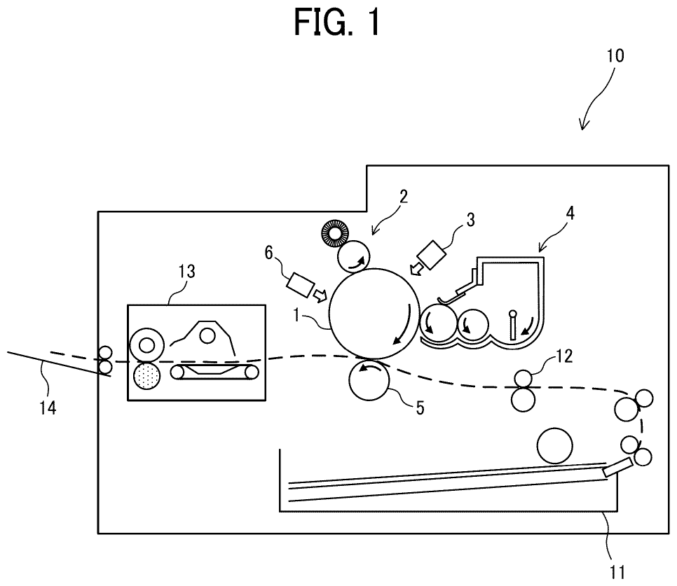

FIG. 1 is a diagram illustrating a configuration of an image forming apparatus 10, according to an embodiment of the present disclosure.

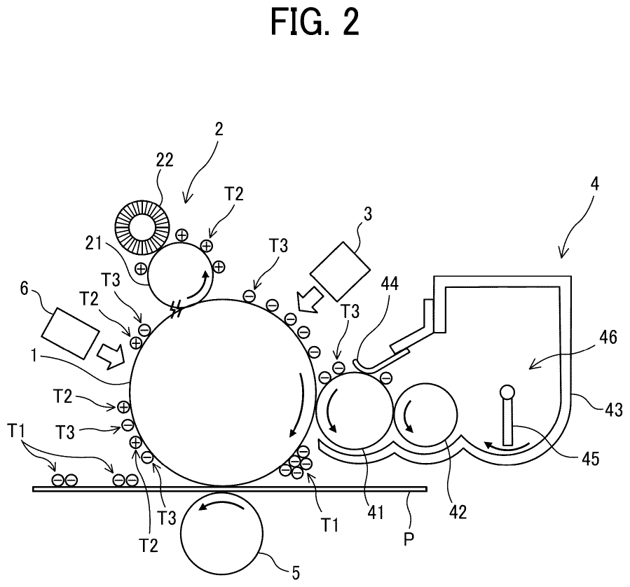

FIG. 2 is a diagram illustrating an image forming device of the image forming apparatus 10, according to an embodiment of the present disclosure.

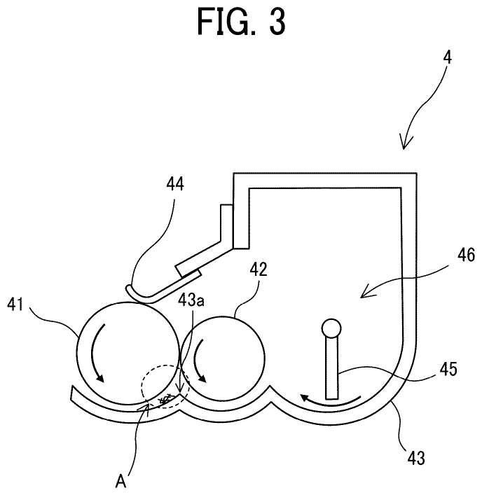

FIG. 3 is a diagram illustrating a configuration of a developing device 4 according to an embodiment of the present disclosure.

The image forming device of the image forming apparatus 10 of the present embodiment includes a drum-shaped photoconductor 1 as a latent image bearer. The image forming device includes a charger 2 as a charger, an optical writing device 3 as a latent image former, a developing device 4 as a developing unit, a transfer device 5 as a transferor, and a static eliminator 6 as an electric-charge remover around the photoconductor 1.

The image forming apparatus 10 according to the present embodiment is a cleanerless image forming apparatus. The image forming apparatus 10 does not include a dedicated cleaning unit for collecting transfer residual toner remaining on the photoconductor 1 after image transfer, and collects the transfer residual toner on the photoconductor 1 into the developing device 4. In the image forming apparatus 10 as the cleanerless image forming apparatus, a space in which a cleaning unit is disposed around the photoconductor 1 can be reduced. Accordingly, the diameter of the photoconductor 1 can be reduced.

Accordingly, for example, even when a recording material onto which a toner image is transferred from the photoconductor 1 is a thin sheet of paper which is likely to be adhered to the surface of the photoconductor 1 after the toner image transfer, the recording material can be reliably separated from the photoconductor 1 only by the curvature of the photoconductor 1. As a result, it is not necessary to provide a recording material separator around the photoconductor 1. Accordingly, as the cleanerless image forming apparatus, the cost and size of the image forming apparatus 10 can be reduced.

In the image forming apparatus 10 according to the present embodiment, a charging bias of, for example, −1100V is applied to a charging roller 21 of the charger 2, and the circumferential surface of the photoconductor 1 is uniformly charged to approximately −500V. Subsequently, the optical writing device 3 including a light emitting diode (LED) array is driven to expose the circumferential surface of the photoconductor 1 in accordance with image data, and lowers the potential of a portion of the circumferential surface of the photoconductor 1 which was exposed to form an electrostatic latent image. Subsequently, in a developing area, the developing device 4 supplies toner as a developer to the electrostatic latent image on the photoconductor 1 to form a toner image on the photoconductor 1. At this time, in the present embodiment, the transfer residual toner that remains on the photoconductor 1 at the time of a previous toner image transfer, is collected in the developing device 4.

In the developing device 4, a developing roller 41 as a developer bearer and a supply roller 42 as a supply rotator are disposed inside a developing case 43 as a developer container. Toner is contained in a toner container 46 inside the developing case 43, and the toner in the toner container 46 is sent to the supply roller 42 by an agitator 45.

The developing roller 41 is rotated in a direction indicated by arrow in FIG. 2 (counterclockwise in FIG. 2), and the toner is supplied to the developing roller 41 from the supply roller 42 which is also rotated in the direction indicated by arrow in FIG. 2 (counterclockwise in FIG. 2). The toner that is supplied to the developing roller 41 is conveyed by the movement of the surface of the developing roller 41, and a regulation blade 44 as a layer thickness regulator forms a thin layer of the toner. Then, the toner is sent to the developing area facing the photoconductor 1.

A developing bias of, for example, −300V, i.e., a negative charging bias, is applied to the developing roller 41. The toner that is sent to the developing area is charged to negative polarity, which is the normal charging polarity, when the toner passes through the regulation blade 44. The toner that is charged to the negative polarity is not adhered to a background surface, as a non-exposed portion, of the photoconductor 1 having the developing bias of about −500V in the developing area. However, the toner is adhered to a latent image, which is exposed, having the developing bias of about −50V on the photoconductor 1. Thus, an electrostatic latent image is developed.

By contrast, a sheet P as a recording material that is fed from a sheet feeder 11 at a predetermined timing is temporarily stopped by a registration roller 12. Subsequently, the sheet P is sent to a transfer area by the registration roller 12 in accordance with a timing at which a toner image T1 on the photoconductor 1 is conveyed to the transfer area.

In the transfer area, a transfer roller of the transfer device 5 is disposed to contact the circumferential surface of the photoconductor 1, and a transfer bias of the positive polarity is applied to the transfer roller. Accordingly, in the transfer area, the toner image T1 on the photoconductor 1 is transferred onto the sheet P fed between the photoconductor 1 and the transfer roller. The sheet P on which the toner image T1 has been transferred is then sent to a fixing device 13, and the toner image T1 is fixed onto the sheet P by pressure and heat. The sheet P onto which the toner image T1 has been fixed is ejected to an output tray 14.

The surface potential of the photoconductor 1 after the transfer of the toner image T1 is leveled to a negative polarity of, for example, about −50V, by the static eliminator 6. Transfer residual toners T2 and T3 that remain on the photoconductor 1 after the toner image T1 has been transferred are conveyed to a charging area in which the photoconductor 1 and the charging roller 21 of the charger 2 contact each other. At this time, in the transfer residual toners T2 and T3, the transfer residual toner T2, which is reversely charged, i.e., charged to the positive polarity, by the transfer bias of the positive polarity, and the transfer residual toner T3, which is charged to the normal charging polarity, i.e., the negative polarity, are mixed.

The transfer residual toner T2 having the positive polarity is mostly changed to the transfer residual toner T3 that has the negative polarity, i.e., the normal charging polarity, by pre-charging discharge generated upstream from the charging area in the movement direction of the circumferential surface of the photoconductor 1. The remaining transfer residual toner T2 having the positive polarity is collected onto the charging roller 21 by the charging bias in an area, i.e., the charging area, opposed to the charging roller 21 of the charger 2.

The charger 2 includes a cleaning brush 22 as a charging cleaner for cleaning, for example, toner adhered onto the charging roller 21. When the transfer residual toner T2 having the positive polarity is collected, a cleaning bias of, for example, −1300V is applied to the cleaning brush 22. Accordingly, the transfer residual toner T2 having the positive polarity, which is adhered onto the charging roller 21 to which the charging bias of −1000V is applied, moves toward the cleaning brush 22 and is held by the cleaning brush 22.

By contrast, the transfer residual toner T3 having the negative polarity passes through the charging area while the transfer residual toner T3 adheres to the photoconductor 1. The amount of the transfer residual toner T3 is considerably small. For this reason, the transfer residual toner T3 does not prevent the charger 2 from charging and the optical writing device 3 from performing exposure. When the transfer residual toner T3 having the negative polarity is conveyed to the developing area, the transfer residual toner T3 contacts the developing roller 41 to which the developing bias of −300V is applied.

At this time, the transfer residual toner T3 on the photoconductor 1 moves onto the developing roller 41 by a potential difference between a potential of −500V of the non-exposed portion, i.e., the background surface of the photoconductor 1 and the developing bias of −300V Thus, the transfer residual toner T3 is collected by the developing device 4. As described above, in the present embodiment, the transfer residual toner T3 is collected in the developing device 4 while the image forming operation is performed. Accordingly, the image forming apparatus 10 functions as the cleanerless image forming apparatus.

The transfer residual toner T2 that has the positive polarity and is held by the cleaning brush 22 during the image forming operation is returned to the photoconductor 1 and collected by the developing device 4 during a non-image-forming operation period, for example, in which the image forming apparatus 10 starts up.

Specifically, in the non-image-forming operation period, first, the charging bias of −1100V is applied to the charging roller 21 to uniformly charge the circumferential surface of the photoconductor 1 to approximately −500V When the circumferential surface of the photoconductor 1 uniformly charged to −500V is conveyed to the charging area again when the transfer bias and the static eliminator 6 are turned off, a voltage of, for example, −350V is applied to the charging roller 21, and at the same time, a voltage of, for example, −150V is applied to the cleaning brush 22. Accordingly, the transfer residual toner T2 that has the positive polarity and is held on the cleaning brush 22 moves from the cleaning brush 22 to the charging roller 21 and, at the same time, from the charging roller 21 to the circumferential surface of the photoconductor 1.

Subsequently, the transfer residual toner T3 that has the positive polarity and is discharged from the charger 2 onto the photoconductor 1 is conveyed to the developing area. At this time, in the developing area, for example, a voltage of +250V is applied to the developing roller 41. Accordingly, the transfer residual toner T2 having the negative polarity on the photoconductor 1 moves to the developing roller 41 and is collected, and at the same time, the transfer residual toner T3 having the positive polarity passes through the developing area.

After the transfer residual toner T3 having the positive polarity passes through the developing area, the transfer residual toner T3 is conveyed to the charging area again. At this time, the static eliminator 6 is turned on to uniformly apply about −50V to the circumferential surface of the photoconductor 1, and at the same time, apply the charging bias of −1100V to the charging rollers 21. Accordingly, the transfer residual toner T3 that has the positive polarity and is conveyed to the charging area becomes the transfer residual toner T3 having the negative polarity, which is the normal charging polarity, by the pre-charging discharge generated upstream from the charging area in the movement direction of the circumferential surface of the photoconductor 1.

Subsequently, when the transfer residual toner T3 having the negative polarity is conveyed to the developing area, the transfer residual toner T3 contacts the developing roller 41 to which the developing bias of −300V is applied in the developing area. Accordingly, the transfer residual toner T3 having the negative polarity moves to the developing roller 41 and is collected into the developing device 4.

In general, not only the transfer residual toners T2 and T3, but also foreign matter such as paper dust adheres to the circumferential surface of the photoconductor 1 after the transfer of the toner image T1. Accordingly, not only the transfer residual toners T2 and T3, but also the foreign matter such as paper dust is collected together in the developing device 4. There is no particular disadvantage when the foreign matter as described above enters the developing device 4. However, if the foreign matter is captured at a facing position at which the developing roller 41 and the regulation blade 44 face each other, and if the foreign matter is accumulated, aggregated, and increases in size, an image defect occurs. Specifically, toner on the developing roller 41 is blocked at a position at which the foreign matter is aggregated. Accordingly, the toner is not sent to the position at which the foreign matter is aggregated in the developing area. As a result, an image defect in which a white streak is generated on the image occurs.

Some developing devices employed in a cleanerless image forming apparatus have a configuration in which surface movement directions of a supply roller and a developing roller are in the same direction at a contact position at which a supply rotator and a developing roller contact each other. However, in the configuration in which the surface movement directions of the supply roller and the developing roller are in the same direction at the contact position at which the supply rotator and the developing roller contact each other, even if the foreign matter that aggregates is prevented from being captured at a facing position at which the supply roller and a regulation blade face each other, and image defects can be prevented from occurring, maintaining image quality of an image having a high image area ratio remains to be difficult.

In other words, in the configuration in which the surface movement directions of the supply roller and the developing roller are in the same direction at the contact position at which the supply roller and the developing roller contact each other, the amount of toner supplied to the developing area is likely to be insufficient, in a case in which continuous developing processing is performed on an image having a high image area ratio. Accordingly, the image density is likely to be reduced.

For this reason, in the present embodiment, the supply roller 42 is rotationally driven to move in the surface movement direction opposite the surface movement direction of the developing roller 41 at a contact position at which the supply roller 42 and the developing roller 41 contact each other. Accordingly, even in the case in which continuous developing processing is performed on an image having a high image area ratio, a shortage of the amount of toner supplied to the developing area is unlikely to occur, and the image quality of an image having a high image area ratio can be maintained.

By contrast, in a configuration in which surface movement directions of a supply roller and a developing roller are opposite each other at a contact position at which the supply roller and the developing roller contact each other, a scraping force of the surface of the supply roller is increased. For example, the surface of the supply roller is polished using a grindstone to form a large number of projections on the surface of the supply roller.

In such a configuration, the ability of the surface of the supply roller that removes the foreign matter such as paper dust collected on the developing roller from the developing roller is increased. Accordingly, the foreign matter that is collected on the developing roller can be prevented from being sent as is to a position at which the developing roller and a regulation blade contact each other. As a result, the foreign matter is prevented from being captured at the position at which the developing roller and the regulating blade contact each other. Thus, for example, the foreign matter that has been captured is prevented from growing. As a result, an image defect can be prevented from occurring.

However, in the configuration in which the scraping force of the surface of the supply roller is increased, the scraped foreign matter remains captured on the surface of the supply roller. Accordingly, the foreign matter is accumulated on the surface of the supply roller. The foreign matter that is accumulated on the surface of the supply roller gradually aggregates and grows, and the aggregate of the foreign matter eventually peels off from the surface of the supply roller. As a result, it has been found that a new disadvantage arises in that the aggregate of the foreign matter is conveyed by the developing roller while being borne on the developing roller and is sandwiched at the position at which the developing roller and the regulation blade contact each other, to cause an image defect.

Accordingly, in the present embodiment, the surface of the supply roller 42 is formed as an adhesion prevention surface to prevent the foreign matter from adhering to the surface of the supply roller 42. Specifically, the surface of the supply roller 42 is a non-projection surface on which no projection is present. However, in consideration of, for example, the capability of the supply roller 42 to supply toner to the developing roller 41, i.e., the capability of the supply roller 42 to remove the foreign matter from the developing roller 41, preferably, recesses are formed on the non-projection surface of the supply roller 42. Specifically, the surface of the supply roller 42 is formed of, for example, a foam layer such as urethane foam.

As described above, the surface of the supply roller 42 is formed as the adhesion prevention surface. By so doing, the foreign matter that is collected from the photoconductor 1 to the developing roller 41 is less likely to accumulate on the surface of the supply roller 42. As a result, the aggregate of the foreign matter does not grow on the surface of the supply roller 42. Accordingly, image defects can be prevented from occurring when the aggregate of the foreign matter is captured at the facing position at which the developing roller 41 and the regulation blade 44 face each other.

In the present embodiment, as illustrated in FIG. 2, an entrance area of the position at which the supply roller 42 and the developing roller 41 contact each other, is positioned in a lower side of the developing roller 41 in the vertical direction. The entrance area is a portion of the developing roller 41 upstream in the surface movement direction of the developing roller 41. Such a configuration as described above allows the foreign matter, which is conveyed to the entrance area in accordance with the surface movement of the developing roller 41 and removed from the developing roller 41 by the surface of the supply roller 42, to move downward by its own weight. Accordingly, the foreign matter is accumulated on a bottom of an inner wall of the developing case 43, i.e., an area surrounded by a dotted-line circle A in FIG. 3.

Specifically, the foreign matter that is conveyed to the entrance area in accordance with the surface movement of the developing roller 41 cannot enter the contact position at which the supply roller 42 and the developing roller 41 contact each other due to the surface movement of the supply roller 42. Accordingly, the foreign matter is removed from the developing roller 41 and stays in the entrance area of the contact position. The foreign matter that stays in the entrance area of the contact position, moves downward by its own weight and is accumulated on the curved surface, i.e., the area surrounded by the dotted-line circle indicated by arrow A in FIG. 3 (which may also be referred to simply as an area A in the following description), of the bottom of the inner wall of the developing case 43, which contacts the developing roller 41.

As a result, the collected foreign matter is prevented from moving around the toner container 46 in the developing case 43 and being carried by the developing roller 41. At the same time, the foreign matter is prevented from being captured and growing at the facing position at which the developing roller 41 and the regulation blade 44 face each other to cause an image defect.

In particular, as illustrated in FIG. 3, the bottom of the inner wall of the developing case 43 of the present embodiment is a curved surface following the circumferential surface of the developing roller 41 and the circumferential surface of the supply roller 42. A projection 43a is formed on the bottom of the inner wall of the developing case 43 toward the entrance area of the contact position at which the supply roller 42 and the developing roller 41 contact each other. The area Ain FIG. 3 in which the foreign matter accumulates is farther from the toner container 46 in the developing case 43 than the projection 43a on the bottom of the inner wall of the developing case 43.

Accordingly, the projection 43a of the bottom of the inner wall of the developing case 43 prevents the foreign matter accumulated in the area A from moving to the toner container 46 in the developing case 43. Accordingly, the foreign matter that is accumulated on the bottom of the inner wall of the developing case 43 is prevented from moving around the toner container 46 in the developing case 43 and being borne by the developing roller 41. At the same time, the foreign matter is prevented from being captured and growing at the facing position at which the developing roller 41 and the regulation blade 44 face each other. Thus, an image defect can be prevented from occurring.

In the present embodiment, the surface movement velocity, i.e., linear velocity, of the supply roller 42 is preferably set to be lower than the surface movement velocity of the developing roller 41. In other words, the linear velocity rate (linear velocity of the supply roller 42/linear velocity of the developing roller 41) is preferably set to be smaller than one. According to this configuration, the foreign matter on the developing roller 41 is likely to be scraped off by the surface of the supply roller 42. Accordingly, the effect of preventing white streak from being generated on an image is enhanced.

In the present embodiment, preferably, the developing roller 41 bites into the supply roller 42 by 1 millimeter (mm) or greater at the contact position at which the supply roller 42 and the developing roller 41 contact each other. According to this configuration, the foreign matter on the developing roller 41 is likely to be scraped off by the surface of the supply roller. Accordingly, the effect of preventing white streak from being generated is enhanced.

The inventors of the present disclosure evaluated types and diameters of cells suitable as the adhesion prevention surface in the case in which the surface of the supply roller 42 is formed of a foamed layer in the developing device 4 of the present embodiment.

The evaluation results are illustrated in Table 1 below.

TABLE 1

| | | | Is Foreign | |
|---|---|---|---|---|
| | | | Matter | |
| | Type of | Diameter of | attached | Did image |
| | Cell of | Cell of | onto Supply | defect (white |
| No. | Supply Rotator | Supply Rotator | Rotator? | streak) occur? |
| 1 | Open-cell | Equal to | YES | YES |
| | Foam | or greater | | |
| | Cell | than 300 μm | | |
| 2 | Single Foam Cell | Smaller than | NO | NO |
| | | 300 μm | | |

As illustrated in Table 1, when the surface of the supply roller 42 is formed of a foam layer including open-cell connected bubbles (cells) each having a diameter equal to or greater than 300 μm, it is confirmed that the foreign matter such as paper dust is trapped in the cells, i.e., recesses formed by the bubbles (cells) present on the surface of the supply roller 42. Note that the diameter of the open-cell connected bubbles (cells) is equivalent to a circle diameter of cells present on the surface of the supply roller 42, in other words, a circle diameter having an area equal to the area of the cells present on the surface of the supply roller 42.

It was also confirmed that the aggregate of the foreign matter was sandwiched at the facing position at which the developing roller 41 and the regulation blade 44 face each other. As a result, the image defect (white streak) occurred. By contrast, when the surface of the supply roller 42 is formed of a foam layer including closed independent bubbles (cells) each having a diameter smaller than 300 μm, the foreign matter such as paper dust was not trapped at the facing position at which the developing roller 41 and the regulation blade 44 face each other. Accordingly, the image defect (white streak) did not occur.

The above-described embodiments are limited examples, and the present disclosure includes, for example, the following aspects having advantageous effects.

### First Aspect

The developing device 4 according to a first aspect includes a developer bearer such as the developing roller 41, a developer such as toner in a developer container such as the toner container 46, a layer thickness regulator such as the regulation blade 44, and a supply rotator such as the supply roller 42. The developing device 4 develops a latent image borne on the developer bearer, and at the same time, collects residual toner such as the residual toner T3, remaining on the latent image bearer. The supply rotator is rotationally driven to move in a surface movement direction opposite a surface movement direction of the developer bearer at a contact position at which the supply rotator and the developer bearer contact each other. The surface of the supply rotator is formed of a foam layer including closed independent bubbles (cells) each having a diameter smaller than 300 μm.

In a developing device employed in a cleanerless image forming apparatus, the foreign matter such as paper dust that is collected from the latent image bearer together with transfer residual toner, is captured between a developer bearer and a layer thickness regulator. The foreign matter is accumulated, aggregated, and grown between the developer bearer and the layer thickness regulator. By so doing, an image defect is likely to occur. Specifically, for example, when the foreign matter is captured between the developer bearer and the layer thickness regulator and grows into the aggregate of the foreign matter, the developer is blocked on the developer bearer at a position at which the aggregate of the foreign matter grows. Accordingly, an image defect in which a white streak is generated on an image occurs.

In order to prevent such an image defect from occurring, a developing device has been proposed in which a supply rotator is rotationally driven such that surface movement directions of the supply rotator and a developer bearer are in the same direction at a contact position at which the supply rotator and the developer bearer contact each other. However, such a developing device may not sufficiently prevent the above-described image defect from occurring.

Specifically, in such a developing device described above in which the surface movement directions of the supply rotator and the developer bearer are in the same direction at the contact position at which the supply rotator and the developer bearer contact each other, the developer that is present in an entrance area upstream from the contact position at which the supply rotator and the developer bearer contact each other, is fed to the position at which the supply rotator and the developer bearer contact each other in accordance with the surface movement directions of both the supply rotator and the developer bearer.

By contrast, the foreign matter that is collected together with the transfer residual toner from the latent image bearer is conveyed to the entrance area in accordance with the surface movement of the developer bearer. Accordingly, the foreign matter that has been conveyed to the entrance area is likely to be sent to the contact position at which the supply rotator and the developer bearer contact each other by the flow of the developer sent to the contact position in accordance with the surface movement of both the supply rotator and the developer bearer. Then, the foreign matter that has been sent to the contact position is conveyed to the position of the layer thickness regulator, while being borne on the developer bearer. By so doing, the foreign matter is captured between the developer bearer and the layer thickness regulator, and an image defect such as a white streak occurs.

Further, in such a developing device described above, even if the foreign matter that is conveyed from the latent image bearer in accordance with the surface movement of the developer bearer is not sent to the contact position at which the supply rotator and the developer bearer contact each other and stays in the entrance area, it is still difficult to maintain the image quality of an image having a high image area ratio. In other words, in the configuration in which the surface movement directions of the supply rotator and the developer bearer are in the same direction at the contact position at which the supply rotator and the developer bearer contact each other, the amount of developer that is supplied to the development region is likely to be insufficient, in a case in which continuous development processing is performed on an image having a high image area ratio. Thus, the image density is likely to be reduced.

By contrast, among developing devices of comparative examples employed in cleanerless image forming apparatuses, a developing device is known in which the surface movement directions of a supply rotator and a developer bearer are opposite each other at a contact position at which the supply rotator and the developer bearer contact each other. In this configuration, even in a case in which continuous development processing is performed on an image having a high image area ratio, a shortage of the amount of developer supplied to the development region is unlikely to occur. Accordingly, the image quality of an image having a high image area ratio can be maintained.

However, such a developing device reliably scrapes off the foreign matter such as paper dust collected on the developer bearer from the developer bearer. For this reason, the surface of the supply rotator is ground by a grindstone, and grinding marks are formed in an opposite direction with respect to the surface movement direction of the developer bearer at the contact position at which the supply rotator and the developer bearer contact each other.

In the above-described developing device, the foreign matter that is conveyed in accordance with the surface movement of the developer bearer is scraped off from the developer bearer by the grinding marks (protrusions) on the surface of the supply rotator. Accordingly, the foreign matter can be prevented from being directly sent to a position between the developer bearer and a layer thickness regulator. Accordingly, it is considered that such a developing device can prevent an image defect from occurring when the foreign matter is captured between the developer bearer and the layer thickness regulator and the foreign matter accumulates, aggregates, and grows between the developer bearer and the layer thickness regulator.

However, in the developing device of the comparative example, the foreign matter that has been scraped off remains captured by the grinding marks on the surface of the supply rotator, and the foreign matter accumulates on the supply rotator. The foreign matter that accumulates on the supply rotator gradually aggregates and grows, and the aggregate of the foreign matter eventually peels off from the supply rotator. As a result, it has been found that a new disadvantage arises in that the aggregate of the foreign matter is borne on the developer bearer and conveyed, and is captured at the position between the developer bearer and the layer thickness regulator. As a result, an image defect occurs.

In the developing device of the first aspect, the supply rotator is rotationally driven to move in the surface movement direction opposite the surface movement direction of the developer bearer at the contact position at which the supply rotator and the developer bearer contact each other. At the same time, the surface of the supply rotator is formed of the foam layer including the single foam cells having a size smaller than 300 μm.

According to this configuration, the surface movement directions of the supply rotator and the developer bearer are opposite each other at the contact position at which the supply rotator and the developer bearer contact each other. Accordingly, even in a case in which continuous development processing is performed on an image having a high image area ratio, the shortage of the amount of the developer supplied to the development region is unlikely to occur. Thus, the image quality of an image having a high image area ratio can be maintained.

Moreover, the surface of the supply rotator is formed of the foam layer including the single foam cells having the diameter smaller than 300 μm, the surface of the supply rotator hardly captures the foreign matter while maintaining the function as the supply rotator. In other words, the supply rotator of the present aspect that has the surface formed of the single foam cells (recesses), reliably performs the function of supplying the developer to the developer bearer and the function to remove foreign matter from the developer bearer.

By contrast, the size of the single foam cell, i.e., the diameter of a circle having an equivalent size of the single foam cell, is smaller than 300 μm. Accordingly, the foreign matter is unlikely to be captured in the recesses, i.e., the single foam cells present on the surface of the supply rotator. Accordingly, the aggregate of the foreign matter does not grow on the supply rotator. Thus, the image defect that is caused by the aggregate of the foreign matter being captured between the developer bearer and the layer thickness regulator, can be prevented from occurring.

Accordingly, the image defect can be prevented from occurring when the foreign matter such as paper dust that is collected together with the transfer residual toner is captured between the developer bearer and the layer thickness regulator. At the same time, the image quality of an image having a high image area ratio can be maintained.

### Second Aspect

In the developing device according to the first aspect, a portion of the developer bearer upstream in the surface movement direction of the developer bearer, is positioned in a lower side of the developer bearer in the vertical direction with respect to the contact position at which the supply rotator and the developer bearer contact each other.

According to this configuration, the foreign matter that is conveyed to the contact position in accordance with the surface movement of the developer bearer and removed from the developer bearer by the surface of the supply rotator moves downward due to its own weight and accumulates on the bottom of the inner wall of the developer container. Accordingly, the foreign matter that has been collected is prevented from moving around the developer container and being borne on the developer bearer. Thus, the foreign matter is prevented from being captured and growing between the developer bearer and the layer thickness regulator. As a result, an image defect can be prevented from occurring.

### Third Aspect

In the developing device according to the first or second aspect, the surface movement velocity of the supply rotator is slower than the surface movement velocity of the developer bearer.

According to this configuration, the foreign matter on the developer bearer is likely to be scraped off by the surface of the supply rotator, and the effect of preventing an image defect due to the foreign matter is enhanced.

### Fourth Aspect

In the developing device according to any one of the first to third aspects, the developer bearer bites into the supply rotator by 1 mm or greater at the contact position at which the supply rotator and the developer bearer contact each other.

According to this configuration, the foreign matter on the developer bearer is likely to be scraped off by the surface of the supply rotator, and the effect of preventing image defects due to the foreign matter is enhanced.

### Fifth Aspect

An image forming apparatus such as the image forming apparatus 10 as a cleanerless image forming apparatus, according to a fifth aspect includes a latent image bearer and the developing device according to any one of the first to fourth aspects, including the developer bearer to collect the residual toner from the latent image bearer.

The image forming apparatus of the fifth aspect can prevent image defects from occurring when the foreign matter such as paper dust that is collected together with the transfer residual toner is captured between the developer bearer and the layer thickness regulator. At the same time, the image quality of an image having a high image area ratio can be maintained.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

1. A developing device comprising:
a developer bearer rotatable in a first direction to supply developer to a latent image bearer;
a developer container to contain the developer to be supplied to the developer bearer;
a supply rotator to supply the developer in the developer container to the developer bearer at a contact position at which the supply rotator contacts the developer bearer;
a layer thickness regulator to form a layer of the developer having a regulated thickness on the developer bearer; and
wherein the developer bearer collects residual toner from the latent image bearer,
the supply rotator rotates in a second direction opposite the first direction of the developer bearer at the contact position, and
the supply rotator has a surface of a foam layer including a single foam cell having a diameter smaller than 300 μm.

2. The developing device according to claim 1,
wherein a portion of the developer bearer upstream from the contact position in the first direction is lower than the contact position.

3. The developing device according to claim 1,
wherein a surface movement velocity of the supply rotator is lower than a surface movement velocity of the developer bearer.

4. The developing device according to claim 1,
wherein the developer bearer bites into the supply rotator by 1 mm or greater at the contact position.

5. An image forming apparatus comprising:
a latent image bearer; and
the developing device according to claim 1, including the developer bearer to collect the residual toner from the latent image bearer.

6. The developing device according to claim 1,
wherein a negative charging bias applied to the developer bearer is higher than a negative charging bias applied to the latent image bearer to generate a potential difference between the developer bearer and the latent image bearer.
